(19) United States
(12) Patent Application Publication
(10) Pub. No.: US 2026/0010136 A1
(43) Pub. Date: Jan. 8, 2026

(54) PROGRAMMABLE LOGIC CONTROLLER, CONTROL METHOD, AND PROGRAM

(71) Applicant: Mitsubishi Electric Corporation, Tokyo (JP)

(72) Inventors: Yoshifumi TAKAKURA, Tokyo (JP); Jun NAKAGAWA, Tokyo (JP)

(73) Assignee: Mitsubishi Electric Corporation, Tokyo (JP)

(21) Appl. No.: 19/119,113

(22) PCT Filed: Mar. 14, 2023
(86) PCT No.: PCT/JP2023/009904

§ 371 Date: Apr. 8, 2025

(51) Int. Cl. G05B 19/05

(52) U.S. Cl. CPC G05B 19/056; G05B 2219/13153

(57) ABSTRACT

When a first program storage memory is used to load a program, a program write controller stores an updated program into a second program storage memory. When the program is loaded in a first program execution memory, a program load controller loads the updated program into a second program execution memory. When a program executor is executing the program loaded in the first program execution memory, an updated-program switch controller causes the program executor to execute the updated program loaded in the second program execution memory.

### TECHNICAL FIELD

The present disclosure relates to a programmable logic controller, a control method, and a program.

### BACKGROUND ART

Program development typically involves debugging to detect and correct errors or anomalies in created programs. To develop a program for a programmable logic controller (hereafter also referred to as a PLC), the programmer checks the operation of the PLC while actually operating the PLC with a created program. When detecting a fault in the operation, the programmer corrects the program and writes the corrected program into the PLC. The programmer repeatedly checks the operation, corrects the program, and writes the corrected program until the PLC operates normally. In developing a PLC program, the debugging may take a long time when the PLC is stopped every time a corrected program is written. A technique is thus awaited for writing a corrected program while minimizing interruption of the operation of the PLC.

Patent Literature 1 describes a PLC device that allows a program held in the device to be rewritten during operation. The PLC device described in Patent Literature 1 includes a first memory as a nonvolatile flash memory to hold a program, a second memory as a nonvolatile flash memory to back up the first memory, and a third memory as a volatile random-access memory (RAM) usable to execute the program. In Patent Literature 1, the PLC device writes a rewritten program into the second memory during operation. When the program has been successfully written, the PLC device copies the written program into the first memory, and further loads the program into the third memory to boot the program.

### CITATION LIST

### Patent Literature

Patent Literature 1: Unexamined Japanese Patent Application Publication No. 2004-272629

### SUMMARY OF INVENTION

### Technical Problem

In the PLC device described in Patent Literature 1, a program loaded in the third memory rewritten during execution is overwritten with the rewritten program and is then booted. Thus, in the PLC device described in Patent Literature 1, the execution of the program before being rewritten is stopped upon the start of loading of the rewritten program. The program execution is thus stopped for a period from the start of loading of the rewritten program to the start of booting of the rewritten program.

Under such circumstances, an objective of the present disclosure is to shorten the time for which program execution is stopped for rewriting the program.

### Solution to Problem

To achieve the above objective, a programmable logic controller according to an aspect of the present disclosure includes a program storage memory to store a program, a program execution memory usable to execute the program, a program load controller to perform control to load the program stored in the program storage memory into the program execution memory, a program executor to execute the program loaded in the program execution memory, and a program write controller to perform write control to store an updated program into the program storage memory. The updated program is the program updated during execution. The program storage memory includes a first program storage memory and a second program storage memory different from the first program storage memory. The program execution memory includes a first program execution memory and a second program execution memory different from the first program execution memory. The program write controller stores the updated program into the second program storage memory when the program storage memory used to load the program being executed is the first program storage memory. The program load controller loads the updated program from the second program storage memory into the second program execution memory when the program execution memory in which the program being executed is loaded is the first program execution memory and the second program storage memory successfully stores the updated program. The programmable logic controller further includes an updated-program switch controller to perform, when the program executor is executing the program loaded in the first program execution memory, switch control to cause the program executor to execute the updated program loaded in the second program execution memory.

### Advantageous Effects of Invention

The programmable logic controller according to the above aspect of the present disclosure loads an updated program into the second program execution memory unused for the program execution. The programmable logic controller according to the above aspect of the present disclosure can thus start loading the updated program without stopping execution of the program before being rewritten. In the above aspect of the present disclosure, the programmable logic controller switches the program execution memory used for the program execution from the first program execution memory to the second program execution memory after the loading of the updated program is complete. Thus, the programmable logic controller according to the above aspect of the present disclosure can switch from executing the program before being rewritten to executing the updated program after being rewritten more rapidly than a programmable logic controller that does not switch the program execution memory from the first program execution memory to the second program execution memory. The programmable logic controller according to the above aspect of the present disclosure can thus shorten the time for which program execution is stopped for rewriting the program.

### BRIEF DESCRIPTION OF DRAWINGS

FIG. 1 is a block diagram of a program development support system according to Embodiment 1;

FIG. 2 is a block diagram of the program development support system, illustrating the functional configuration;

FIG. 3 is a block diagram of a PLC and an engineering tool, illustrating the hardware configuration;

FIG. 4 is a diagram describing an example process from receiving a program to storing a management table;

FIG. 5 is a diagram describing an example process from receiving an updated program to storing the updated program;

FIG. 6 is a diagram describing an example process from loading the updated program to storing a management table;

FIG. 7 is a flowchart of an updated-program switch control process;

FIG. 8 is a diagram describing an example process from synchronizing program execution memories to loading a second updated program; and

FIG. 9 is a diagram describing an example process from loading the second updated program without synchronizing the program execution memories to loading non-updated programs.

### DESCRIPTION OF EMBODIMENTS

A programmable logic controller, a control method, and a program according to one or more embodiments of the present disclosure are described below in detail with reference to the drawings. Like reference signs denote like or corresponding components in the drawings. The programmable logic controller is hereafter referred to as a PLC.

### Program Development Support System 1

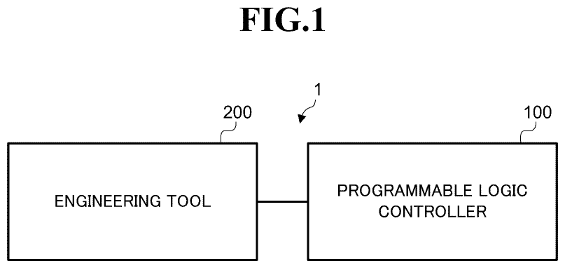

A program development support system 1 according to an embodiment of the present disclosure supports program development by performing debugging. As illustrated in FIG. 1, the program development support system 1 includes a PLC 100 that executes a program, and an engineering tool 200 that generates and updates a program. The PLC 100 and the engineering tool 200 are connected to each other with a network that can transmit and receive information.

In the program development support system 1, the engineering tool 200 transmits a program generated by a user (programmer) to the PLC 100. The PLC 100 stores, loads, and executes the received program. The user checks the operation of the PLC 100 executing the program, and corrects and updates the program when detecting a fault in the operation. The engineering tool 200 transmits the updated program to the PLC 100. The PLC 100 stores, loads, and executes the received updated program. The program development support system 1 repeats, until the PLC 100 operates normally, the user's checking the operation and correcting and updating the program, the engineering tool 200 transmitting the updated program, and the PLC 100 receiving, storing, loading, and executing the updated program. In this manner, the program development support system 1 can support debugging programs and developing programs.

### PLC 100

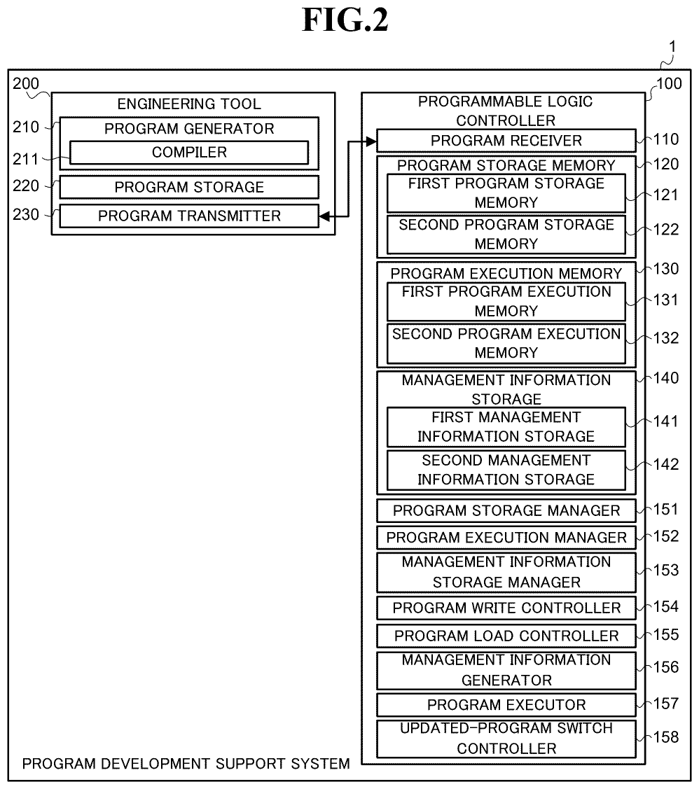

As illustrated in FIG. 2, the PLC 100 includes a program receiver 110 that receives a program. The PLC 100 also includes a program storage memory 120 that stores a program, a program execution memory 130 usable to execute a program, and a management information storage 140 that stores management information for managing execution of a program. The program storage memory 120 includes a first program storage memory 121 and a second program storage memory 122. The program execution memory 130 includes a first program execution memory 131 and a second program execution memory 132. The management information storage 140 includes a first management information storage 141 and a second management information storage 142.

The PLC 100 also includes a program storage manager 151 that manages the program storage memory 120, a program execution manager 152 that manages the program execution memory 130, and a management information storage manager 153 that manages the management information storage 140. The PLC 100 also includes a program write controller 154 that performs write control to write a program, a program load controller 155 that performs control to load a program, and a management information generator 156 that generates management information. The PLC 100 also includes a program executor 157 that executes a program, and an updated-program switch controller 158 that performs switch control to switch to an updated program that is the program updated.

### Engineering Tool 200

As illustrated in FIG. 2, the engineering tool 200 includes a program generator 210 that generates a program, a program storage 220 that stores a program, and a program transmitter 230 that transmits a program. The program generator 210 includes a compiler 211 that compiles a program.

### Hardware Configuration of PLC 100

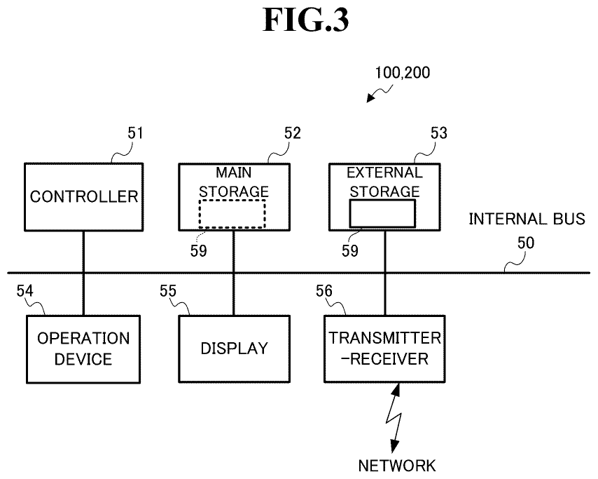

As illustrated in FIG. 3, the PLC 100 includes a controller 51 that performs processing based on a control program 59. The controller 51 includes a central processing unit (CPU). The controller 51 functions, based on the control program 59, as the program storage manager 151, the program execution manager 152, the management information storage manager 153, the program write controller 154, the program load controller 155, the management information generator 156, the program executor 157, and the updated-program switch controller 158 illustrated in FIG. 2.

Referring back to FIG. 3, the PLC 100 includes a main storage 52 in which the control program 59 is loaded. The main storage 52 is used as a work area for the controller 51. The main storage 52 includes a volatile memory such as a random-access memory (RAM). The main storage 52 functions as the program execution memory 130, the first program execution memory 131, the second program execution memory 132, the management information storage 140, the first management information storage 141, and the second management information storage 142 illustrated in FIG. 2.

Referring back to FIG. 3, the PLC 100 includes an external storage 53 that prestores the control program 59. The external storage 53 provides information stored in the program to the controller 51 as instructed by the controller 51, and stores data provided from the controller 51. The external storage 53 includes a nonvolatile memory such as a flash memory, a hard disk drive (HDD), or a solid-state drive (SSD). The external storage 53 functions as the program storage memory 120, the first program storage memory 121, and the second program storage memory 122 illustrated in FIG. 2.

Referring back to FIG. 3, the PLC 100 includes an operation device 54 operable by the user. Information input through the operation device 54 is provided to the controller 51. The operation device 54 includes information input components such as a keyboard, a mouse, or a touchscreen.

The PLC 100 also includes a display 55 that displays information input through the operation device 54 and information output from the controller 51. The display 55 includes a display device such as a liquid crystal display (LCD) or an organic electroluminescent (EL) display.

The PLC 100 also includes a transmitter-receiver 56 that transmits and receives information. The transmitter-receiver 56 includes information communication components such as a communication network terminator or a wireless communication device connected to the network. The transmitter-receiver 56 functions as the program receiver 110 illustrated in FIG. 2.

Referring back to FIG. 3, the main storage 52, the external storage 53, the operation device 54, the display 55, and the transmitter-receiver 56 are connected to the controller 51 with an internal bus 50 in the PLC 100.

The PLC 100 implements the functions of the components 110, 120 to 122, 130 to 132, 140 to 142, and 151 to 158 illustrated in FIG. 2 with the controller 51 using the main storage 52, the external storage 53, the operation device 54, the display 55, and the transmitter-receiver 56 as resources. For example, the PLC 100 performs a program storage management step as an example of a program reception step performed by the program receiver 110 and a program storage determination step performed by the program storage manager 151.

The PLC 100 also performs, for example, a program execution management step as an example of a program execution determination step performed by the program execution manager 152 and a management information storage management step as an example of a management information storage determination step performed by the management information storage manager 153. The PLC 100 also performs, for example, a program write control step performed by the program write controller 154, a program load control step performed by the program load controller 155, and a management information generation step performed by the management information generator 156. The PLC 100 also performs, for example, a program execution step performed by the program executor 157 and an updated-program switch control step performed by the updated-program switch controller 158.

### Hardware Configuration of Engineering Tool 200

As illustrated in FIG. 3, the engineering tool 200 includes a controller 51, a main storage 52, an external storage 53, an operation device 54, a display 55, and a transmitter-receiver 56, similarly to the PLC 100. The controller 51 functions as the program generator 210 and the compiler 211 illustrated in FIG. 2, the external storage 53 functions as the program storage 220, and the transmitter-receiver 56 functions as the program transmitter 230, based on the control program 59. Referring back to FIG. 3, the engineering tool 200 implements the functions of the components 210, 211, 220, and 230 illustrated in FIG. 2 with the controller 51 using the main storage 52, the external storage 53, the operation device 54, the display 55, and the transmitter-receiver 56 as resources. For example, the engineering tool 200 performs a program generation step performed by the program generator 210, a compilation step performed by the compiler 211, and a program transmission step performed by the program transmitter 230.

### Details of Functional Configuration of Engineering Tool 200

Referring back to FIG. 2, when receiving a user operation on the operation device 54 to write a program, the program generator 210 writes the program. The program may be written in a text data format or in a graphical data format. For example, the program may be written as a source code in a structured text (ST) language or as a ladder diagram in a ladder language. When receiving a user operation on the operation device 54 to compile a program, the program generator 210 causes the compiler 211 to compile the program. The program generator 210 stores the source file for the generated program and the executable file for the compiled program into the program storage 220.

The program transmitter 230 transmits the executable file for the program stored in the program storage 220 to the PLC 100. While the PLC 100 is executing the executable file for the program received from the engineering tool 200, the user may detect a fault in the operation of the PLC 100 and may correct and update the program. In this case, the program generator 210 generates the source file and the executable file for the updated program and stores these files into the program storage 220. The program transmitter 230 transmits the executable file for the updated program stored in the program storage 220 to the PLC 100.

### Details of Functional Configuration of PLC 100

The program receiver 110 receives the executable file for a program from the engineering tool 200. When the user corrects and updates the program during execution, the program receiver 110 receives the executable file for the updated program from the engineering tool 200. The executable file for a program is hereafter simply referred to as a program. The executable file for an updated program is hereafter simply referred to as an updated program.

In the present embodiment, the first program execution memory 131 is a first volatile memory. The second program execution memory 132 is a second volatile memory that is separate from the first volatile memory. The first program storage memory 121 is a first nonvolatile memory. The second program storage memory 122 is a second nonvolatile memory that is separate from the first nonvolatile memory. The first management information storage 141 is a specific area in the first volatile memory in which no program is loaded. The second management information storage 142 is a specific area in the second volatile memory.

The program write controller 154 performs write control to store the executable file for a program received by the program receiver 110 into the program storage memory 120. When no program is being executed, the program write controller 154 synchronizes the program information stored in the first program storage memory 121 with the program information stored in the second program storage memory 122.

The program write controller 154 then stores the received program into the first program storage memory 121.

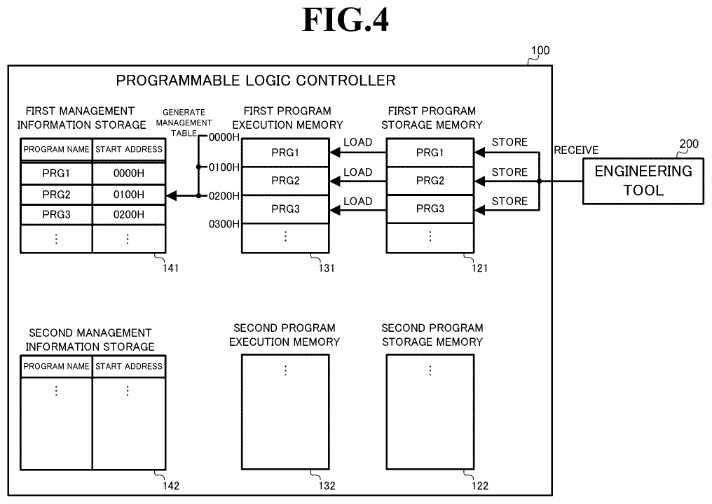

For example, as illustrated in FIG. 4, a first program PRG1, a second program PRG2, and a third program PRG3 may be received from the engineering tool 200. With no program information stored in the first program storage memory 121 or the second program storage memory 122, these memories are synchronized with each other as illustrated in FIG. 4. In this case, the program write controller 154 stores the received programs PRG1 to PRG3 into a free space in the first program storage memory 121.

Referring back to FIG. 2, when the program storage memory 120 successfully stores a program, the program load controller 155 performs control to load the program stored in the program storage memory 120 into the program execution memory 130. When no program is being executed, the program load controller 155 loads a program stored in the first program storage memory 121 into the first program execution memory 131.

For example, as illustrated in FIG. 4, after the first program storage memory 121 successfully stores the programs PRG1 to PRG3, the program load controller 155 first loads the first program PRG1 stored in the first program storage memory 121 into the first program execution memory 131 at a first address 0000H to a second address 0100H. The program load controller 155 also loads the second program PRG2 stored in the first program storage memory 121 into the first program execution memory 131 at the second address 0100H to a third address 0200H. The program load controller 155 also loads the third program PRG3 stored in the first program storage memory 121 into the first program execution memory 131 at the third address 0200H to a fourth address 0300H. In other words, the program load controller 155 loads the programs PRG1 to PRG3 into the first program execution memory 131 at the first address 0000H to the fourth address 0300H in a continuous manner.

Referring back to FIG. 2, the management information generator 156 generates a management table as an example of management information before a program is executed, and stores the generated management table into the management information storage 140. The management table indicates the location addresses of programs loaded in the program execution memory 130. When no program is being executed, the management information generator 156 generates a management table indicating the location address of a program loaded in the first program execution memory 131, and stores the generated management table into the first management information storage 141.

For example, as illustrated in FIG. 4, after the programs PRG1 to PRG3 are

loaded into the first program execution memory 131, the management information generator 156 generates a management table indicating the first program PRG1 with the start location address being the first address 0000H, the second program PRG2 with the start location address being the second address 0100H, and the third program PRG3 with the start location address being the third address 0200H. The management information generator 156 then stores the generated management table into the first management information storage 141.

Referring back to FIG. 2, the program executor 157 executes a program loaded in the program execution memory 130 using the management table stored in the management information storage 140. When no program is being executed, the program executor 157 executes a program loaded in the first program execution memory 131 using the management table stored in the first management information storage 141.

For example, as illustrated in FIG. 4, the program executor 157 identifies, based on the management table stored in the first management information storage 141, the programs PRG1, PRG2, and PRG3 respectively having the start location addresses of 0000H, 0100H, and 0200H. The program executor 157 executes the programs PRG1 to PRG3 at the identified locations in the first program execution memory 131.

Referring back to FIG. 2, when the program receiver 110 receives an updated program during execution of a program, the program storage manager 151 as an example of a program storage determiner determines whether the program storage memory 120 used to load the program being executed is the first program storage memory 121 or is the second program storage memory 122. When, for example, a program storage memory flag (not illustrated) indicates the value 1, the program storage manager 151 determines that the program storage memory 120 used to load the program being executed is the first program storage memory 121. When the program storage memory flag indicates the value 2, the program storage manager 151 determines that the program storage memory 120 used to load the program being executed is the second program storage memory 122.

When the updated program is received and the determination result from the program storage manager 151 is the first program storage memory 121, the program write controller 154 synchronizes the information stored in the second program storage memory 122 with the information stored in the first program storage memory 121. The program write controller 154 then stores the received updated program into the second program storage memory 122. When the determination result from the program storage manager 151 is the second program storage memory 122, the program write controller 154 synchronizes the information stored in the first program storage memory 121 with the information stored in the second program storage memory 122. The program write controller 154 then stores the received updated program into the first program storage memory 121.

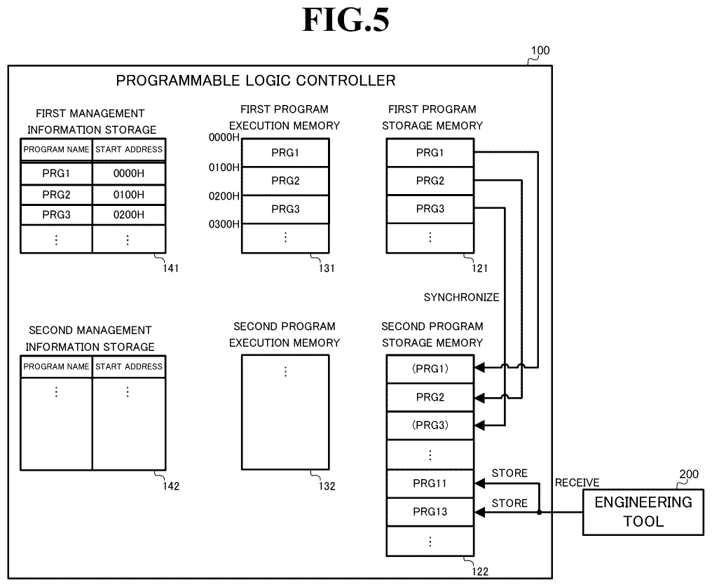

For example, as illustrated in FIG. 5, a first updated program PRG11 that is the first program PRG1 updated and a third updated program PRG13 that is the third program PRG3 updated may be received from the engineering tool 200 during execution of the programs PRG1 to PRG3. In this case, the program storage manager 151 determines that the program storage memory 120 storing the programs being executed is the first program storage memory 121. The program write controller 154 then stores the programs PRG1 to PRG3 stored in the first program storage memory 121 into the second program storage memory 122 to synchronize the information of the programs PRG1 to PRG3. The program write controller 154 stores the received updated programs PRG11 and PRG13 into a free space in the second program storage memory 122.

Referring back to FIG. 2, when the program write controller 154 successfully writes an updated program during execution of a program, the program execution manager 152 as an example of a program execution determiner determines whether the program execution memory 130 in which the program being executed is loaded is the first program execution memory 131 or is the second program execution memory 132. When, for example, a program execution memory flag (not illustrated) indicates the value 1, the program execution manager 152 determines that the program execution memory 130 in which the program being executed is loaded is the first program execution memory 131. When the program execution memory flag indicates the value 2, the program execution manager 152 determines that the program execution memory 130 in which the program being executed is loaded is the second program execution memory 132.

When the updated program has been successfully stored and the determination result from the program execution manager 152 is the first program execution memory 131, the program load controller 155 loads the updated program stored in the second program storage memory 122 into the second program execution memory 132. The program load controller 155 then loads, into the second program execution memory 132, a non-updated program that has been loaded and executed in the first program execution memory 131. When the determination result from the program execution manager 152 is the second program execution memory 132, the program load controller 155 loads the updated program stored in the first program storage memory 121 into the first program execution memory 131. The program load controller 155 then loads, into the first program execution memory 131, a non-updated program that has been loaded and executed in the second program execution memory 132.

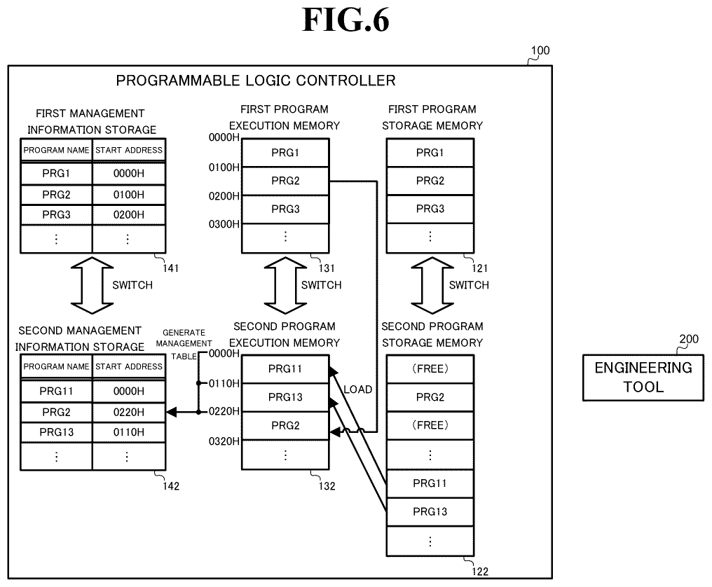

For example, as illustrated in FIG. 6, after the second program storage memory 122 successfully stores the updated programs PRG11 and PRG13, the program load controller 155 loads the first updated program PRG11 stored in the second program storage memory 122 into the second program execution memory 132 at the first address 0000H to the second address 0110H that are examples of a first memory area. The program load controller 155 also loads the third updated program PRG13 stored in the second program storage memory 122 into the second program execution memory 132 at the second address 0110H to the third address 0220H that are examples of the first memory area. The program load controller 155 also loads the second program PRG2 stored in the first program execution memory 131 into the second program execution memory 132 at the third address 0220H to the fourth address 0320H that are examples of a second memory area. In other words, the program load controller 155 loads the programs PRG11, PRG13, and PRG2 into the second program execution memory 132 at the first address 0000H to the fourth address 0320H in a continuous manner.

Referring back to FIG. 2, when the program load controller 155 performs control to load an updated program during execution of a program, the management information storage manager 153 as an example of a management information storage determiner determines whether the management information storage 140 storing the management table used for the program being executed is the first management information storage 141 or is the second management information storage 142. When, for example, a management information storage flag (not illustrated) indicates the value 1, the management information storage manager 153 determines that the management information storage 140 storing the management table used for the program being executed is the first management information storage 141. When the management information storage flag indicates the value 2, the program storage manager 151 determines that the management information storage 140 storing the management table used for the program being executed is the second management information storage 142.

When the determination result from the management information storage manager 153 is the first management information storage 141, the management information generator 156 generates a management table indicating the location address of the updated program loaded in the second program execution memory 132. The management information generator 156 then stores the generated management table into the second management information storage 142. When the determination result from the management information storage manager 153 is the second management information storage 142, the management information generator 156 generates a management table indicating the location address of the updated program loaded in the first program execution memory 131. The management information generator 156 then stores the generated management table into the first management information storage 141.

More specifically, as illustrated in FIG. 6, the management information generator 156 generates a management table indicating the first updated program PRG11 with the start location address being the first address 0000H, the second program PRG2 with the start location address being the second address 0220H, and the third updated program PRG13 with the start location address being the third address 0110H. The management information generator 156 then stores the generated management table into the second management information storage 142.

Referring back to FIG. 2, when the program executor 157 is executing a program loaded in the first program execution memory 131 using the management table stored in the first management information storage 141, the updated-program switch controller 158 causes the program executor 157 to execute an updated program loaded in the second program execution memory 132 using the management table stored in the second management information storage 142. When the program executor 157 is executing a program loaded in the second program execution memory 132 using the management table stored in the second management information storage 142, the updated-program switch controller 158 causes the program executor 157 to execute an updated program loaded in the first program execution memory 131 using the management table stored in the first management information storage 141.

For example, as illustrated in FIG. 6, each of the program execution memory 130 and the management information storage 140 referred to by the program executor 157 is switched. More specifically, the updated-program switch controller 158 switches the volatile memory used by the program executor 157 from the first volatile memory to the second volatile memory. Thus, the program executor 157 identifies, based on the management table stored in the second management information storage 142, the programs PRG11, PRG2, and PRG13 respectively having the start location addresses of 0000H, 0220H, and 0110H. The program executor 157 stops executing the programs PRG1 to PRG3 and executes the programs PRG11, PRG2, and PRG13 at the identified locations in the second program execution memory 132. After the programs PRG11, PRG2, and PRG13 are executed, the updated-program switch controller 158 updates the value indicated by each of the program storage memory flag, the program execution memory flag, and the management information storage flag from 1 to 2.

### Flowchart of Updated-Program Switch Control Process

The control for supporting the program development performed by the program development support system 1 is now described with reference to the flowchart. The process of generating or updating a program and transmitting the program to the PLC 100 performed in the engineering tool 200 simply includes generating or updating a program based on a user operation and storing the program into the program storage 220 with the program generator 210, and transmitting the generated or updated program to the PLC 100 with the program transmitter 230.

The process of executing a program performed in the PLC 100 simply includes receiving the executable file for a program from the engineering tool 200 with the program receiver 110, storing the program into the first program storage memory 121 with the program write controller 154, loading the program into the first program execution memory 131 with the program load controller 155, generating a management table and storing the management table into the first management information storage 141 with the management information generator 156, and executing the program using the management table with the program executor 157.

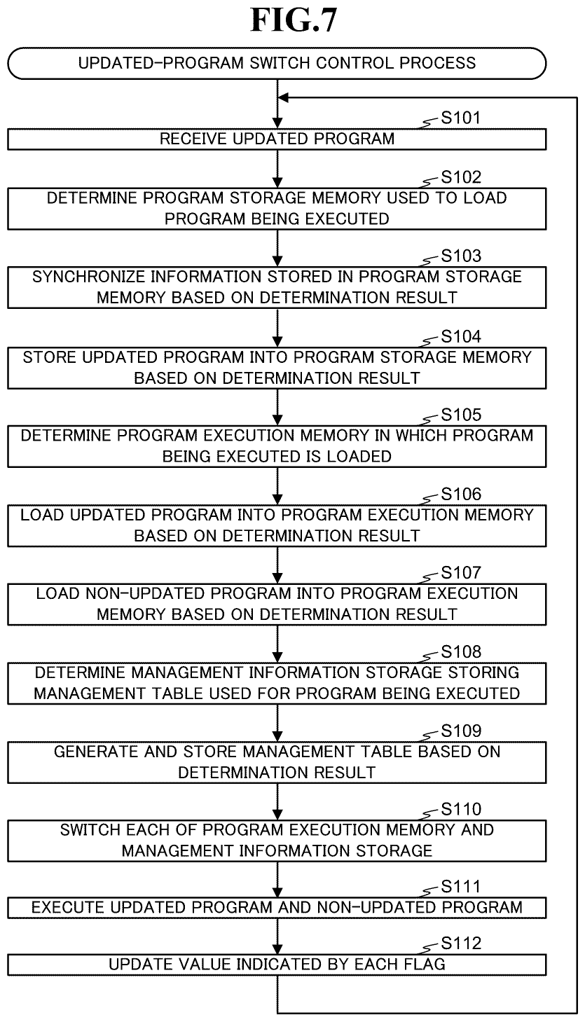

To reduce redundancy, the processes described above are not illustrated or described in detail. The control performed by the PLC 100 to switch a program being executed to an updated program is described below. The PLC 100 starts an updated-program switch control process illustrated in FIG. 7 when the program executor 157 starts executing a program.

The program receiver 110 first receives an updated program (step S101). For example, when the user detects a fault in the operation of the PLC 100 and corrects and updates the programs PRG1 and PRG3 during execution of the programs PRG1 to PRG3, the program receiver 110 receives the first updated program PRG11 and the third updated program PRG13 from the engineering tool 200.

The program storage manager 151 then determines whether the program storage memory 120 used to load the program being executed is the first program storage memory 121 or is the second program storage memory 122 (step S102). When, for example, the program storage memory flag indicates the value 1, the program storage manager 151 determines that the first program storage memory 121 is used to load the programs PRG1 to PRG3 being executed.

The program write controller 154 then synchronizes the information stored in the program storage memory 120 based on the determination result from the program storage manager 151 (step S103). For example, the program write controller 154 stores the programs PRG1 to PRG3 stored in the first program storage memory 121 also into the second program storage memory 122.

The program write controller 154 then stores the updated program into the program storage memory 120 based on the determination result from the program storage manager 151 (step S104). For example, the program write controller 154 stores the updated programs PRG11 and PRG13 into the second program storage memory 122.

The program execution manager 152 then determines whether the program execution memory 130 in which the program being executed is loaded is the first program execution memory 131 or is the second program execution memory 132 (step S105). When, for example, the program execution memory flag indicates the value 1, the program execution manager 152 determines that the programs PRG1 to PRG3 being executed are loaded in the first program execution memory 131.

The program load controller 155 then loads the updated program stored in the program storage memory 120 into the program execution memory 130 based on the determination result from the program execution manager 152 (step S106). For example, the program load controller 155 loads the updated programs PRG11 and PRG13 from the second program storage memory 122 into the second program execution memory 132 at the first address 0000H to the third address 0220H in a continuous manner.

The program load controller 155 then loads a program that has been loaded and has not been updated into the program execution memory 130 based on the determination result from the program execution manager 152 (step S107). For example, the program load controller 155 loads the second program PRG2 from the first program execution memory 131 into the second program execution memory 132 at the third address 0220H to the fourth address 0320H to have the second program PRG2 continuous with the updated programs PRG11 and PRG13.

The management information storage manager 153 then determines whether the management information storage 140 storing the management table used for the program being executed is the first management information storage 141 or is the second management information storage 142 (step S108). When, for example, the management information storage flag indicates the value 1, the management information storage manager 153 determines that the first management information storage 141 stores the management table used for the program being executed.

The management information generator 156 then generates, based on the determination result from the management information storage manager 153, a management table indicating the location address of the updated program loaded in the program execution memory 130. The management information generator 156 then stores the management table into the management information storage 140 (step S109). For example, the management information generator 156 generates a management table indicating the first updated program PRG11 with the start location address being the first address 0000H, the second program PRG2 with the start location address being the second address 0220H, and the third updated program PRG13 with the start location address being the third address 0110H. The management information generator 156 then stores the management table into the second management information storage 142.

The updated-program switch controller 158 then switches each of the program execution memory 130 and the management information storage 140 used by the program executor 157 (step S110). For example, the updated-program switch controller 158 switches the volatile memory used by the program executor 157 from the first volatile memory to the second volatile memory.

The program executor 157 executes the updated program and the non-updated program (step S111). For example, the program executor 157 identifies, based on the management table stored in the second management information storage 142, the programs PRG11, PRG2, and PRG13 respectively having the start location addresses of 0000H, 0220H, and 0110H. The program executor 157 stops executing the programs PRG1 to PRG3 and executes the programs PRG11, PRG2, and PRG13 at the identified locations in the second program execution memory 132.

The updated-program switch controller 158 then updates the value indicated by each of the program storage memory flag, the program execution memory flag, and the management information storage flag (step S112), and returns to step S101. For example, the updated-program switch controller 158 updates the value indicated by each of the program storage memory flag, the program execution memory flag, and the management information storage flag from 1 to 2.

As described above, in the program development support system 1 according to the present embodiment, the program load controller 155 in the PLC 100 performs control to load a program stored in the program storage memory 120 into the program execution memory 130. The program executor 157 executes the program loaded in the program execution memory 130. The program write controller 154 performs write control to store an updated program into the program storage memory 120 during execution of the program.

The program storage memory 120 is a nonvolatile memory and includes the first program storage memory 121 as a first nonvolatile memory and the second program storage memory 122 as a second nonvolatile memory. The program execution memory 130 is a volatile memory and includes the first program execution memory 131 as a first volatile memory and the second program execution memory 132 as a second volatile memory.

When the program storage memory 120 used to load the program being executed is the first program storage memory 121, the program write controller 154 stores the updated program into the second program storage memory 122. When the program execution memory 130 in which the program being executed is loaded is the first program execution memory 131 and the second program storage memory 122 successfully stores the updated program, the program load controller 155 loads the updated program from the second program storage memory 122 into the second program execution memory 132.

In this manner, the PLC 100 according to the present embodiment stores the received updated program into the program storage memory 120 as a nonvolatile memory. The received updated program can thus be held in the program storage memory 120 when a power outage occurs. Thus, in the PLC 100 according to the present embodiment, the program execution memory 130 as a volatile memory eliminates any component for holding information to prepare against a power outage.

In the program development support system 1 according to the present embodiment, when the program executor 157 is executing a program loaded in the first program execution memory 131, the updated-program switch controller 158 performs switch control to cause the program executor 157 to execute an updated program loaded in the second program execution memory 132.

In the PLC device in Patent Literature 1 described above, a program loaded in the third memory updated during execution starts being executed after the update. In this device, the execution of the program is stopped upon the start of the update. Thus, the PLC device described in Patent Literature 1 stops the program execution for a period from the start of update of the program to the start of execution of the updated program.

In particular, the PLC device described in Patent Literature 1 loads the updated program from the first memory as a nonvolatile flash memory into the third memory as a volatile RAM. This structure may prolong the period for which program execution is stopped. With a prolonged period for which program execution is stopped, the PLC device described in Patent Literature 1 is more likely to cause improper control timing for a factory automation (FA) device. This may cause the FA device to produce a warning sound or may have a failure.

In contrast, the PLC 100 according to the present embodiment loads an updated program into the second program execution memory 132 unused for the program execution. In this manner, the PLC 100 according to the present embodiment can start loading the updated program without stopping execution of the program before being rewritten. The PLC 100 according to the present embodiment switches the program execution memory 130 used for the program execution from the first program execution memory 131 to the second program execution memory 132 after loading the updated program and generating and storing the management table. This greatly shortens the processing time for the switch control. In this manner, the PLC 100 according to the present embodiment can switch from executing the program before being rewritten to executing the updated program after being rewritten more rapidly than a PLC that does not switch the program execution memory from the first program execution memory to the second program execution memory.

The PLC 100 according to the present embodiment can thus shorten the time for which program execution is stopped for rewriting the program. The PLC 100 according to the present embodiment is thus less likely to cause improper control timing for the FA device that is controlled based on the updated program. This reduces warning sounds produced by the FA device or failures in the FA device.

The PLC device described in Patent Literature 1 stores a received updated program into the second memory as a nonvolatile flash memory. The PLC device then copies the updated program stored in the second memory into the first memory as a nonvolatile flash memory, and then loads the copied updated program from the first memory into the third memory. The PLC device described in Patent Literature 1 may thus prolong the period from receiving the updated program to loading the updated program into the third memory.

In contrast, the PLC 100 according to the present embodiment stores a received updated program into the second program storage memory 122 unused for the program execution, and then loads the updated program into the second program execution memory 132. In this manner, the PLC 100 according to the present embodiment can shorten the period from receiving an updated program to loading the updated program into the program execution memory than a PLC that copies the updated program into the nonvolatile memory after storing the received updated program into the program storage memory and before loading the updated program into the program execution memory.

Structured programming has recently been common in programming for PLCs. Structured programming uses variables such as global variables or local variables in programs, instead of using the known devices. To correct and update global variables that are common to multiple programs, in particular, the programmer is to correct and update all the programs that use the global variables. Recent programming for PLCs thus tends to involve more programs to be corrected and updated at a time.

With more programs to be corrected and updated at a time, the PLC device described in Patent Literature 1 may prolong the period for which program execution is stopped or prolong the period from receiving an updated program to loading the updated program into the program execution memory.

With more programs to be updated, the PLC 100 according to the present embodiment can shorten such periods as compared with the PLC device described in Patent Literature 1.

In the program development support system 1 according to the present embodiment, the management information generator 156 generates a management table that is the information for managing execution of a program, and stores the management table into the management information storage 140. The program executor 157 executes a program loaded in the program execution memory 130 using the management table stored in the management information storage 140. The management information generator 156 also generates a management table for managing execution of an updated program. When the management information storage 140 storing the management table used for the program being executed is the first management information storage 141, the management information generator 156 stores the generated management table into the second management information storage 142. When the program executor 157 is executing a program loaded in the first program execution memory 131 using the management table stored in the first management information storage 141, the updated-program switch controller 158 performs the switch control to cause the program executor 157 to execute an updated program loaded in the second program execution memory 132 using the management table stored in the second management information storage 142.

In this manner, the PLC 100 according to the present embodiment stores the newly generated management table into the second management information storage 142 unused for the program execution. This structure can start generating the management table without stopping execution of the program before being rewritten. The PLC 100 according to the present embodiment switches the management information storage 140 used for the program execution from the first management information storage 141 to the second management information storage 142 after generating and storing the management table. This greatly shortens the processing time for the switch control. In this manner, the PLC 100 according to the present embodiment can shorten the time taken for generating and storing the management table, as compared with a PLC that does not switch the management information storage from the first management information storage to the second management information storage. The PLC 100 can further shorten the time taken for switching from executing the program before being rewritten to executing the updated program after being rewritten.

In the program development support system 1 according to the present embodiment, the program includes the first program PRG1 and the third program PRG3. The updated program includes the first updated program PRG11 that is the first program PRG1 updated and the third updated program PRG13 that is the third program PRG3 updated. When the first program storage memory 121 is used to load the programs PRG1 to PRG3 being executed, the program write controller 154 stores the first updated program PRG11 and the third updated program PRG13 into the second program storage memory 122.

When the programs PRG1 to PRG3 being executed are loaded in the first program execution memory 131 and the second program storage memory 122 successfully stores the first updated program PRG11 and the third updated program PRG13, the program load controller 155 loads the first updated program PRG11 and the third updated program PRG13 from the second program storage memory 122 into the second program execution memory 132. The management information generator 156 generates a management table for managing execution of the first updated program PRG11 and the third updated program PRG13. When the first management information storage 141 stores the management table used for the programs PRG1 to PRG3 being executed, the management information generator 156 stores the generated management table into the second management information storage 142.

When the program executor 157 is executing the first program PRG1 and the third program PRG3 loaded in the first program execution memory 131 using the management table stored in the first management information storage 141, the updated-program switch controller 158 causes the program executor 157 to execute the first updated program PRG11 and the third updated program PRG13 loaded in the second program execution memory 132 using the management table stored in the second management information storage 142.

In this manner, the PLC 100 according to the present embodiment can perform, for multiple updated programs received, a single switch control process to switch from executing the program before being rewritten to executing the updated program after being rewritten. The PLC 100 according to the present embodiment can thus shorten the time for which program execution is stopped for rewriting the program, as compared with a PLC that performs more than a single switch control process to switch from executing the program before being rewritten to executing the updated program after being rewritten for multiple updated programs received. With more programs to be updated, the PLC 100 can further shorten the time for which program execution is stopped.

In the program development support system 1 according to the present embodiment, the program further includes the second program PRG2. When the first program storage memory 121 is used to load the programs PRG1 to PRG3 being executed, the program write controller 154 stores the updated programs PRG11 and PRG13 into the second program storage memory 122.

When the programs PRG1 to PRG3 being executed are loaded in the first program execution memory 131 and the second program storage memory 122 successfully stores the updated programs PRG11 and PRG13, the program load controller 155 loads the updated programs PRG11 and PRG13 from the second program storage memory 122 into the second program execution memory 132, and loads the second program PRG2 from the first program execution memory 131 into the second program execution memory 132.

The management information generator 156 generates a management table for managing execution of the updated programs PRG11 and PRG13 and the second program PRG2. When the first management information storage 141 stores the management table used for the programs PRG1 to PRG3 being executed, the management information generator 156 stores the generated management table into the second management information storage 142. When the program executor 157 is executing the programs PRG1 to PRG3 loaded in the first program execution memory 131 using the management table stored in the first management information storage 141, the updated-program switch controller 158 causes the program executor 157 to execute the updated programs PRG11 and PRG13 and the second program PRG2 loaded in the second program execution memory 132 using the management table stored in the second management information storage 142.

In this manner, when updated programs have not been received for all the programs being executed, the PLC 100 according to the present embodiment can load the non-updated second program PRG2 from the first program execution memory 131 used to execute the second program PRG2 into the second program execution memory 132 unused to execute the second program PRG2. Thus, the PLC 100 according to the present embodiment can shorten the time taken to load a non-updated program as compared with a PLC that loads the non-updated program from the first program storage memory or the second program storage memory as a nonvolatile memory into the second program execution memory.

More specifically, in the program development support system 1 according to the present embodiment, the program load controller 155 loads the updated programs PRG11 and PRG13 into the second program execution memory 132 in a continuous manner at the first address 0000H to the third address 0220H that are the first memory area. The program load controller 155 loads the second program PRG2 into the second program execution memory 132 at the third address 0220H to the address 0320H that are the second memory area subsequent to and continuous with the first memory area.

In this manner, the PLC 100 according to the present embodiment can load the updated programs PRG11 and PRG13 and the non-updated second program PRG2 into the first memory area to the second memory area in a continuous manner. The PLC 100 according to the present embodiment can thus prevent fragmentation of the program execution memory 130 after repeated reception of updated programs.

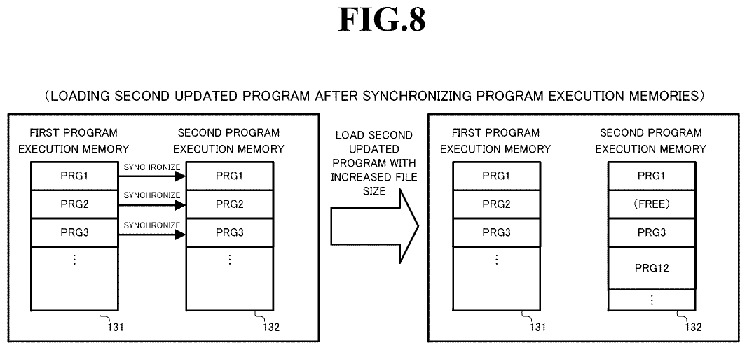

In an example described below, a PLC synchronizes the memories in the program storage memory 120 before a program is written, and also synchronizes the memories in the program execution memory 130 before the control to load programs is performed. More specifically, the PLC receives the second updated program PRG12 that is the second program PRG2 updated during execution of the programs PRG1 to PRG3. The second updated program PRG12 has a file size increased from the second program PRG2. In such a PLC, after the second updated program PRG12 is loaded into the second program execution memory 132, the memory area in the second program execution memory 132 storing the second program PRG2 becomes a free space, as illustrated in FIG. 8. Although the second updated program PRG12 is loaded in a manner continuous with the third program PRG3, the PLC may undergo memory fragmentation, with the memory area that has stored the second program PRG2 being a free space.

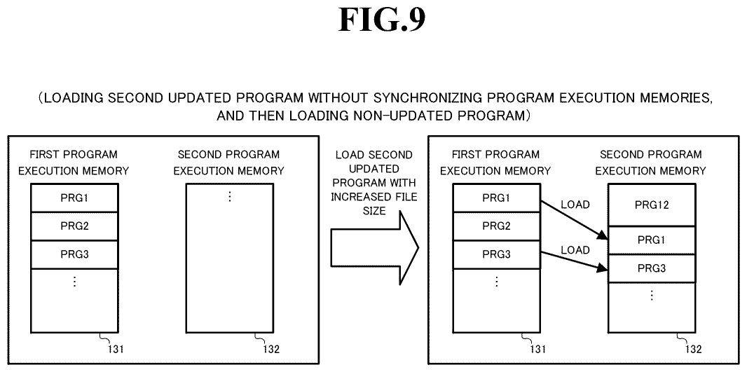

In contrast, the PLC 100 according to the present embodiment does not synchronize the memories in the program execution memory 130 before the control to load programs is performed. Thus, as illustrated in FIG. 9, the PLC 100 according to the present embodiment can load the non-updated programs PRG1 and PRG3 in a manner continuous with the second updated program PRG12 after loading the second updated program PRG12. This can avoid memory fragmentation. The PLC 100 according to the present embodiment is thus less likely to undergo memory fragmentation and shortage of the available memory area than a PLC that synchronizes the memories in the program execution memory 130 before the control to load programs is performed.

In the program development support system 1 according to the present embodiment, the program storage manager 151 determines whether the program storage memory 120 used to load the program being executed is the first program storage memory 121 or is the second program storage memory 122. The program execution manager 152 determines whether the program execution memory 130 in which the program being executed is loaded is the first program execution memory 131 or is the second program execution memory 132. The management information storage manager 153 determines whether the management information storage 140 storing the management table used for the program being executed is the first management information storage 141 or is the second management information storage 142.

In this manner, during execution of a program, the PLC 100 according to the present embodiment can manage the effective program storage memory 120, the effective program execution memory 130, and the effective management information storage 140 that are used to execute the program separately from the ineffective program storage memory 120, the ineffective program execution memory 130, and the ineffective management information storage 140 that are unused to execute the program.

### Modifications

In the above embodiment, the program write controller 154 synchronizes the program information stored in the first program storage memory 121 with the program information stored in the second program storage memory 122 after the program receiver 110 receives an updated program. However, the program information may be synchronized at any other timing. For example, the program write controller 154 may synchronize the program information stored in the first program storage memory 121 with the program information stored in the second program storage memory 122 after the program executor 157 executes a program and an updated program.

As in the above embodiment, the program load controller 155 may load updated programs when all the updated programs have been successfully stored by the program write controller 154. However, this is not limitative. For example, the program load controller 155 may load at least one of the received updated programs that has been successfully stored by the program write controller 154.

As in the above embodiment, the program load controller 155 may load the non-updated second program PRG2 from the first program execution memory 131 as a volatile memory into the second program execution memory 132. However, this is not limitative. For example, the program load controller 155 may load the non-updated second program PRG2 from the first program storage memory 121 or the second program storage memory 122 as a nonvolatile memory into the second program execution memory 132.

In the above embodiment, the updated-program switch controller 158 updates the value indicated by each of the program storage memory flag, the program execution memory flag, and the management information storage flag to 1 or 2. However, any number of flags may be used. For example, the updated-program switch controller 158 may use a volatile memory flag combining the program execution memory flag and the management information storage flag, with the program execution memory 130 and the management information storage 140 being included in the same volatile memory. The updated-program switch controller 158 may update the value indicated by the volatile memory flag to 1 or 2. In this case, the program execution manager 152 and the management information storage manager 153 are to manage the program execution memory 130 and the management information storage 140 based on the value indicated by the volatile memory flag that is updated by the updated-program switch controller 158. In another example, the updated-program switch controller 158 may use a switch flag combining all of the program storage memory flag, the program execution memory flag, and the management information storage flag. The updated-program switch controller 158 may update the value indicated by the switch flag to 1 or 2. In this case, the program storage manager 151, the program execution manager 152, and the management information storage manager 153 are to manage the program storage memory 120, the program execution memory 130, and the management information storage 140 based on the value indicated by the switch flag that is updated by the updated-program switch controller 158.

In the above embodiment, the updated-program switch controller 158 updates the program storage memory flag, the program execution memory flag, and the management information storage flag. However, each of these flags may be updated by a component other than the updated-program switch controller 158. For example, the program write controller 154 or the program storage manager 151 may update the program storage memory flag after the program write controller 154 performs the write control for writing into the program storage memory 120. For example, the program load controller 155 or the program execution manager 152 may update the program execution memory flag after the program load controller 155 performs control to load an updated program into the program execution memory 130. For example, the management information generator 156 or the management information storage manager 153 may update the management information storage flag after the management information generator 156 generates a management table and stores the management table into the management information storage 140.

In the above embodiment, the program receiver 110 receives, as updated programs, the first updated program PRG11 that is the first program PRG1 updated and the third updated program PRG13 that is the third program PRG3 updated. However, the updated programs are not limited to these. For example, the program receiver 110 may receive, as an updated program, the second updated program PRG12 that is the second program PRG2 updated. When the program receiver 110 receives the first updated program PRG11 and the second updated program PRG12 as updated programs, the PLC 100 may perform control corresponding to the control described above but with the third updated program PRG13 replaced with the second updated program PRG12. To reduce redundancy, the example in which the program receiver 110 receives the first updated program PRG11 and the second updated program PRG12 as updated programs is not illustrated or described in detail.

In the above embodiment, the program storage memory 120 includes two memories, or specifically, the first program storage memory 121 and the second program storage memory 122. In some embodiments, the program storage memory 120 may include three or more memories. In this case, the program storage manager 151 is to manage the three or more memories in the program storage memory 120. The program write controller 154 is to perform write control for writing into the three or more memories in the program storage memory 120. The updated-program switch controller 158 is to control switching among the three or more memories in the program storage memory 120.

In the above embodiment, the program execution memory 130 includes two memories, or specifically, the first program execution memory 131 and the second program execution memory 132. In some embodiments, the program execution memory 130 may include three or more memories. In this case, the program execution manager 152 is to manage the three or more memories in the program execution memory 130. The program load controller 155 is to perform control for loading into the three or more memories in the program execution memory 130. The updated-program switch controller 158 is to control switching among the three or more memories in the program execution memory 130.

In the above embodiment, the management information storage 140 includes two storages, or specifically, the first management information storage 141 and the second management information storage 142. In some embodiments, the management information storage 140 may include three or more storages. In this case, the management information storage manager 153 is to manage the three or more memories in the management information storage 140. The management information generator 156 is to store generated management tables into the three or more memories in the management information storage 140. The updated-program switch controller 158 is to control switching among the three or more storages in the management information storage 140.

In the above embodiment, the first management information storage 141 is a specific area in the first volatile memory that is the first program execution memory 131, and the second management information storage 142 is a specific area in the second volatile memory that is the second program execution memory 132. However, the management information storages 141 and 142 may have any other structures. For example, the first management information storage 141 and the second management information storage 142 may be a first specific area and a second specific area in a third volatile memory.

The main part of the PLC 100 including the controller 51, the main storage 52, the external storage 53, the operation device 54, the transmitter-receiver 56, and the internal bus 50 may allow the PLC 100 to perform the processes by, for example, installing a program for the above operations stored and distributed in a non-transitory recording medium readable by the PLC 100 such as a flash memory. The program may be stored in a storage device included in a server device on a communication network such as a local area network (LAN) or the Internet, and may be downloaded by the PLC 100 to provide a computer.

When the functions of the PLC 100 are implemented by the operating system (OS) and an application program in a shared manner or through cooperation between the OS and the application program, portions executable by the application program may be stored in a non-transitory recording medium or a storage device.

The program may also be superimposed on a carrier wave to be provided through a communication network. For example, the program may be posted on a bulletin board system (BBS) on the communication network to be provided through a network. The above processes may be performed by booting the program and executing the program under the control of the OS similarly to other application programs.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### REFERENCE SIGNS LIST

1 Program development support system
50 Internal bus
51 Controller
52 Main storage
53 External storage
54 Operation device
55 Display
56 Transmitter-receiver
59 Control program
100 PLC
110 Program receiver
120 Program storage memory
121 First program storage memory
122 Second program storage memory
130 Program execution memory
131 First program execution memory
132 Second program execution memory
140 Management information storage
141 First management information storage
142 Second management information storage
151 Program storage manager
152 Program execution manager
153 Management information storage manager
154 Program write controller
155 Program load controller
156 Management information generator
157 Program executor
158 Updated-program switch controller
200 Engineering tool
210 Program generator
211 Compiler
220 Program storage
230 Program transmitter

1. A programmable logic controller, comprising:
a program storage memory to store a program;
a program execution memory usable to execute the program;
a program load controller to perform control to load the program stored in the program storage memory into the program execution memory;
a program executor to execute the program loaded in the program execution memory; and
a program write controller to perform write control to store an updated program into the program storage memory, the updated program being the program updated during execution,
wherein the program storage memory includes a first program storage memory and a second program storage memory different from the first program storage memory,
the program execution memory includes a first program execution memory and a second program execution memory different from the first program execution memory,
the program write controller stores the updated program into the second program storage memory when the program storage memory used to load the program being executed is the first program storage memory,
the program load controller loads the updated program from the second program storage memory into the second program execution memory when the program execution memory in which the program being executed is loaded is the first program execution memory and the second program storage memory successfully stores the updated program,
the programmable logic controller further comprises an updated-program switch controller to perform, when the program executor is executing the program loaded in the first program execution memory, switch control to cause the program executor to execute the updated program loaded in the second program execution memory,
the updated-program switch controller performs, in the switch control, control to switch the program execution memory used by the program executor from the first program execution memory to the second program execution memory, and
the program executor ends execution of the program being executed that is loaded in the first program execution memory as a result of the switching of the program execution memory based on the switching control, and starts execution of the updated program that is loaded in the second program execution memory.

2. The programmable logic controller according to claim 1, further comprising:
a management information generator to generate management information for managing execution of the program; and
a management information storage to store the management information,
wherein the program executor executes the program loaded in the program execution memory using the management information stored in the management information storage,
the management information storage includes a first management information storage and a second management information storage different from the first management information storage,
the management information generator generates the management information for managing execution of the updated program, and stores the generated management information for managing execution of the updated program into the second management information storage when the management information storage storing the management information used for the program being executed is the first management information storage, and
when the program executor is executing the program loaded in the first program execution memory using the management information stored in the first management information storage, the updated-program switch controller performs the switch control to cause the program executor to execute the updated program loaded in the second program execution memory using the management information stored in the second management information storage.

3. The programmable logic controller according to claim 1, further comprising:
a program storage determiner to determine whether the program storage memory used to load the program being executed is the first program storage memory or is the second program storage memory; and
a program execution determiner to determine whether the program execution memory in which the program being executed is loaded is the first program execution memory or is the second program execution memory.

4. The programmable logic controller according to claim 1, wherein
the program includes a first program and a second program different from the first program,
the updated program includes a first updated program being the first program updated and a second updated program being the second program updated,
the program write controller stores the first updated program and the second updated program into the second program storage memory when the program storage memory used to load the first program and the second program being executed is the first program storage memory,
the program load controller loads the first updated program and the second updated program from the second program storage memory into the second program execution memory when the program execution memory in which the first program and the second program being executed are loaded is the first program execution memory and the second program storage memory successfully stores the first updated program and the second updated program, and
when the program executor is executing the first program and the second program loaded in the first program execution memory, the updated-program switch controller causes the program executor to execute the first updated program and the second updated program loaded in the second program execution memory.

5. The programmable logic controller according to claim 1, wherein
the program includes a first program and a second program different from the first program,
the updated program is a first updated program being the first program updated,
the program write controller stores the first updated program into the second program storage memory when the program storage memory used to load the first program and the second program being executed is the first program storage memory,
the program load controller loads the first updated program from the second program storage memory into the second program execution memory and loads the second program from the first program execution memory into the second program execution memory when the program execution memory in which the first program and the second program being executed are loaded is the first program execution memory and the second program storage memory successfully stores the first updated program, and
when the program executor is executing the first program and the second program loaded in the first program execution memory, the updated-program switch controller causes the program executor to execute the first updated program and the second program loaded in the second program execution memory.

6. The programmable logic controller according to claim 5, wherein
the program load controller loads the first updated program into a first memory area in the second program execution memory, and then loads the second program into a second memory area in the second program execution memory, and the second memory area is subsequent to and continuous with the first memory area.

7. A control method for a programmable logic controller, the method comprising:
performing, with the programmable logic controller, control to load a program stored in a program storage memory into a program execution memory being usable to execute the program;
executing, with the programmable logic controller, the program loaded in the program execution memory; and
performing, with the programmable logic controller, write control to store an updated program into the program storage memory, the updated program being the program updated during execution,
wherein the program storage memory includes a first program storage memory and a second program storage memory different from the first program storage memory,
the program execution memory includes a first program execution memory and a second program execution memory different from the first program execution memory,
performing the write control includes storing the updated program into the second program storage memory when the program storage memory used to load the program being executed is the first program storage memory,
performing the control to load the program includes loading the updated program from the second program storage memory into the second program execution memory when the program execution memory in which the program being executed is loaded is the first program execution memory,
the method further comprises performing, with programmable logic controller, switch control to execute the updated program loaded in the second program execution memory when the program loaded in the first program execution memory is being executed,
performing the switch control to execute the updated program includes performing, with the programmable logic controller, performing control to switch the program execution memory used in the executing of the program from the first program execution memory to the second program execution memory, and
executing the program includes ending, with the programmable logic controller, execution of the program being executed that is loaded in the first program execution memory as a result of the switching of the program execution memory based on the switching control, and starting, with the programmable logic controller, execution of the updated program that is loaded in the second program execution memory.

8. A program for causing a programmable logic controller to function as:
a program load controller to perform control to load a program stored in a program storage memory into a program execution memory being usable to execute the program;
a program executor to execute the program loaded in the program execution memory; and
a program write controller to perform write control to store an updated program into the program storage memory, the updated program being the program updated during execution,
wherein the program storage memory includes a first program storage memory and a second program storage memory different from the first program storage memory,
the program execution memory includes a first program execution memory and a second program execution memory different from the first program execution memory,
the program write controller stores the updated program into the second program storage memory when the program storage memory used to load the program being executed is the first program storage memory,
the program load controller loads the updated program from the second program storage memory into the second program execution memory when the program execution memory in which the program being executed is loaded is the first program execution memory and the second program storage memory successfully stores the updated program,
the program further causes the programmable logic controller to function as an updated-program switch controller to perform, when the program executor is executing the program loaded in the first program execution memory, switch control to cause the program executor to execute the updated program loaded in the second program execution memory,
the updated-program switch controller performs, in the switch control, control to switch the program execution memory used by the program executor from the first program execution memory to the second program execution memory, and
the program executor ends execution of the program being executed that is loaded in the first program execution memory as a result of the switching of the program execution memory based on the switching control, and starts execution of the updated program that is loaded in the second program execution memory.
